(19) United States
(12) Patent Application Publication
(10) Pub. No.: US 2006/0136316 A1
(43) Pub. Date: Jun. 22, 2006

(54) Using event contracts to hedge idiosyncratic risk

(76) Inventors: Brian Chia-Huan Shiau, Scottsdale, AZ (US); Stephen Buford Smith JR., Brentwood, TN (US)

Correspondence Address: Brian Chia-Huan Shiau;Suite 115, 1295 West Washington Street, Tempe, AZ, 85281, US

(21) Appl. No.: 11/312,915

(22) Filed: Dec. 20, 2005

Related U.S. Application Data
(60) Provisional application No. 60/637,380, filed on Dec. 20, 2004.

(51) Int. Cl. G06Q 40/00

(52) U.S. Cl. 705/35

(57) ABSTRACT

A method for hedging in which the hedging party holds an underlying investment subject to idiosyncratic risk, identifies events giving rise to idiosyncratic risk affecting the investment, and takes a position in an event contract providing for a payout to the hedging party if the event giving rise to the idiosyncratic risk occurs. An investor may choose to determine whether the market has mispriced the risk as a factor in deciding whether to employ this hedging methodology. An investor may choose to determine whether employing the hedge will result in less variability in possible outcomes or a smaller possible maximum loss as factors in deciding whether to employ this strategy. This method may be used with various forms of event contracts or combinations of event contracts, including but not limited to vanilla event option contracts, digital event option contracts, event forward contracts, event futures contracts and event swap contracts. The investment being hedged can be illiquid, a short position or even an operational investment. Operational investments that can be hedged using this method include issued insurance contracts. The hedge can be implemented by taking either a long or a short position in event contracts.

### REFERENCE TO RELATED PROVISIONAL APPLICATION

This application claims the benefit of the filing date of U.S. provisional patent application Serial No. 60/637380, filed Dec. 20, 2004, by Brian Chia-Huan Shiau and Stephen Buford Smith, Jr. and entitled METHOD FOR HEDGING SPECIFIC IDIOSYNCRATIAC EVENT RISK IN A RISKY INVESTMENT BY IDENTIFYING, ISOLATING, AND EXTRACTING SPECIFIC IDIOSYNCRATIC EVENT RISK USING SPECIALLY TAILORED EVENT CONTRACTS.

### BACKGROUND

1. Field of the Invention

This invention relates to the use of event contracts to hedge specific nonsystematic or idiosyncratic risk in an investment. Investors who hold a position in a company's securities—whether long or short—may use this invention to hedge against the future occurrence of an event that would cause the value of the company's security to move adversely to the position taken by the investor. The company itself may use this invention to hedge against the possible occurrence of events that would affect negatively investments a company has made using its own or borrowed capital, including allowing a company to hedge idiosyncratic risk affecting insurance policies it has issued. This invention may be used to hedge a position in any investment that faces idiosyncratic risk.

2. Background of the Invention

Financial derivatives, which can take the form of among other things, forwards, futures, options and swaps, have in common the trait that their value depends on an underlying financial instrument or security such as a stock or bond.

A forward or forward contract sets a price upon its initiation at which the contracting parties will exchange one asset for another at a specified, subsequent time. A forward contract on a stock, for example, would set a price upon its initiation at which the counter parties to the contract would exchange stock for cash when the contract expires at a future date.

Futures or futures contracts are a type of forward contract with standardized contract terms that trade on an organized, government regulated exchange. The standardized contract terms specify a standardized quantity of a good, a specified delivery date and delivery mechanism. In addition, a clearinghouse—a financial institution affiliated with the exchange on which the futures trade—enforces performance on futures contracts by the counter parties. Futures contracts also require that traders post margin—a monetary deposit meant to cover potential financial obligations arising from trading the futures contract.

Options contracts or options give their owners the right but not the obligation to buy, in the case of call options, or to sell, in the case of put options, an underlying good, such as a company's stock or bond, at a specified “strike” price for a preset amount of time. When the preset amount of time has lapsed, the option “expires.” With respect to options traded on an organized exchange, the seller, otherwise known as the writer of an option, receives a payment or premium from the owner, otherwise known as the buyer or owner of the option in exchange for giving the right to exercise the option. A stock call option is in the money when the actual price of the stock exceeds the option's strike price and is out of the money when the option's strike price exceeds the stock price. A stock put option is in the money when the option's strike price exceeds the stock price and is out of the money when the stock price exceeds the option's strike price.

Swap agreements give two or more parties—the counter parties—the obligation to exchange prespecified sequences of cash flows over a prespecified future time frame. Typically, one set of cash flows that is being swapped reflects the cash flows of one type of asset, such as a bond with a fixed interest rate, while the other cash flow being swapped reflects the cash flows of another type of asset, such as a bond with an adjustable interest rate.

Financial derivatives can also be combined in a variety of ways. An option on a futures contract, for example, is an option that takes a futures contract, rather than a stock or bond, as its underlying good. The buyer or owner of the option, in exchange for a premium paid to the seller, has the right to purchase the futures contract from the seller of the option.

Financial derivatives may be used to hedge—to reduce a preexisting risk arising from another position held by the hedger—against an adverse change in the value of the underlying financial asset.

An investor who has purchased a stock at $10.00 per share, for example, and thus is “long” that stock may purchase by paying a premium put options that allow the investor to sell the stock at, for example, $10.00 a share to the seller of the put options for a set period of time. This permits the investor to hedge against the risk of the stock price falling below $10.00 a share.

An investor who has sold short a stock at $10.00 per share and is thus “short” that stock may purchase by paying a premium call options that allow the investor to buy the stock at, for example, $10.00 a share from the seller of the call options for a set period of time. This procedure allows the investor to hedge against the risk of the stock price rising above $10.00, which in this scenario results in a loss to the investor's short position in the stock.

Financial derivatives that depend on the price of an underlying security, such as a stock or bond rather than the probability that an event affecting the price of the underlying security might occur, cannot implement a hedge narrowly tailored to address only those identifiable idiosyncratic risks associated with a particular security or other investment that concern an investor. Investors perceive the risk associated with a risky asset—an asset with uncertain future returns—as a bundle of conceptually distinct risks. Systematic risk consists of that part of the asset's risk—its variability of returns—that affect all risky assets and thus cannot be diversified away—an example of which are macroeconomic factors. The remainder of the risk associated with a risky asset consists of its idiosyncratic or unsystematic risk—factors that are unique to an asset and that are traditionally dealt with through diversification. The hedging permitted by financial derivatives cannot isolate and protect against the occurrence of identifiable idiosyncratic risks but rather hedges price volatility—changes in the price of the underlying asset—irrespective of its cause.

Event contracts refer to a class of instruments designed to allocate the risk of an event occurring among the parties to the contract. Such event contracts can be structured to take the same forms and combinations of forms as financial derivatives and thus include, for example, futures contracts (“event futures”), options contracts (“event options”), swap agreements (“event swaps”) and forward contracts (“event forwards”).

Event options can take the form of digital event options. As currently constructed and implemented, the writer or seller of a digital event option contract and the buyer or holder of the contract agree to exchange a fixed payout contingent on whether the event covered by the option occurs. The buyer or owner of the option is “long” the event occurring and receives that fixed payment from the seller if the event or “strike” on which a payout under the contract is based occurs within an agreed to time horizon. The seller or writer of the option is “short” the event occurring and receives the fixed payment from the buyer if the event or strike does not occur. In other words, the digital event option is in the money with respect to the buyer and owner of the option if the event occurs and is in the money with respect to the seller if the event does not occur. There are only two possible outcomes—hence the “binary” or “digital” nature of these event option contracts. Unlike an equity option, digital event options typically do not require the buyer to pay the seller a premium upon initiation of the digital event option contract because the seller in the case of a digital event option is compensated by the opportunity to receive a fixed payout from the buyer if the event in question does not occur. Instead, the price paid by the buyer to the seller and by the seller to the buyer to enter into the digital event option contract is not exchanged until the contract expires and is secured by margin deposits. Though the size of payout to the buyer and seller of the same digital event option contract is the same, the price paid by the buyer and seller may differ depending on the market's assessment of the probability of the event occurring. Thus, the net gain (payout from option contract minus price paid for contract) may differ for the buyer and seller.

Vanilla event option contracts, as currently constructed and implemented, vary or scale the payment made by the seller or writer of the contract to the buyer depending on how far an event results from the “strike.” If the event or strike on which a vanilla event option contract is based is whether President Bush wins the popular vote, the seller only pays the buyer if President Bush wins the popular vote in an election (thus the buyer is “long” a victory by President Bush) in which case the vanilla event option is in the money. Unlike the digital event option, however, the payout under the vanilla event option scales and is proportionate to President Bush's margin of victory in the popular vote. Vanilla event options also differ from digital event options in that the buyer pays the seller a premium in exchange for the right to receive a variable payment from the seller. The seller, unlike a seller of a digital event option, receives only the premium and not the reciprocal right to receive a payment from the buyer if the event does not occur.

To give another example of how an event contract may be structured, a forward event contract would allow two counter parties to agree on a payment from one counter party to the other if the event occurs. The buyer, who receives the payment from the seller if the event occurs, would be long the event or strike and the seller, who receives the payment from the buyer if the event or strike does not occur, takes a short position. The payout under an event forward, or future if it is traded on an exchange, varies with the degree by which the actual result surpasses or falls short of the strike. The payout scales like a vanilla event call or vanilla event put but, unlike such vanilla event options, an event forward or future requires a payment from buyer to seller if the event does not occur.

Event contracts that provide a scaled payment—one calibrated to the extent by which an event surpasses or falls short of a numerical benchmark—work best with statistical events. Statistical events whose outcome can be quantified, such as the extent to which a company's total revenue for a future quarter meets the company's projections, give rise to idiosyncratic risk for investors in that company. An event forward contract or an event option contract could be written in which the company's reaching a particular dollar value in total sales in a given fiscal quarter would be the strike or event. Payout to the buyer or seller under an event forward or future would be on a sliding scale with larger amounts payable to the buyer the greater the extent to which the strike is exceeded and to the seller the greater the extent to which the sales figure falls short of the strike.

An event option contract may also be structured as an event swap contract or event swap. To use a swap to allocate the risk of an event occurring, the contract would require the seller to make a payment or series of payments to the buyer if the specified event occurs in exchange for a payment or series of fixed payments from the buyer. The amount of the payments can be scaled as with a vanilla event option and event forwards and futures or they can be fixed as with a digital option.

The names of event contracts currently traded on exchanges reflect the type of event whose risk of occurrence the event contract is designed to allocate. Presidential futures are event contracts whose payout depends on whether a particular candidate wins the United States presidential election. So-called weather derivatives are structured to make payout from such event contracts depend on the weather.

Event contracts have been fashioned and traded on organized exchanges that concern the outcome of sporting events (e.g., tradesports.com), political contests (e.g., Iowa Electronic Markets), macroeconomic variables such as the unemployment rate (e.g., hedgestreet.com), and box office results for a movie (tradesports.com). Regardless of name or purpose, all event contracts allocate the risk of an event occurring among counter parties by conditioning some aspect of the payout (e.g., whether to pay, the amount to pay, to whom to pay) on whether an event or strike on which the contract is based has occurred and in some cases on the extent to which the occurrence surpasses or falls short of the numerical benchmark used as the event or strike.

Event contracts targeted at a macroeconomic benchmark (e.g. unemployment rate, payroll counts or manufacturing numbers) have been used as investment hedges. Macroeconomic variables and the possible impact they have on the variance of future investment returns necessarily target systematic risk, which include factors that affect all risky assets such as macroeconomic factors, rather than the idiosyncratic risk targeted by a hedging strategy using the possible occurrence of an idiosyncratic risk factor as the strike. Macroeconomic event contracts as investment hedges first came into use because they complement diversified portfolio strategies that have already mitigated the idiosyncratic risk exposure through diversification but still needed to mitigate systematic risk exposure.

Macroeconomic event contracts have also been used by individuals who wish to hedge against adverse movements in macroeconomic factors that affect their financial security, such as the unemployment rate or energy prices. This approach treats event contracts as a primary investment vehicle. There is no underlying investment whose variability of returns is being hedged. In contrast, the methodology encompassed by this invention uses event contracts as investment hedges.

Credit derivatives are event contracts that target credit risk for fixed income instruments or bonds in an all inclusive way by allocating the risk of a default for a fixed income instrument among the counter parties. Credit derivatives fail to target particular events that constitute idiosyncratic risk factors affecting default risk for a bond issued by a company, such as potential earnings shortfalls and litigation losses faced by the issuing company. Accordingly, these instruments negate the entire bundle of idiosyncratic risks rather than target particular events that constitute idiosyncratic risk factors.

The primary method for reducing idiosyncratic risk in an investment has long been to diversify the portfolio by increasing the number of holdings so that idiosyncratic risk represents a smaller and systematic risk a larger portion of total portfolio risk. This invention—the use of event contracts to target and permit hedging against an investment's specific idiosyncratic risk factors—gives investors an alternative, novel way to reduce idiosyncratic risk through the use of event contracts targeted at idiosyncratic risk factors as hedging instruments. Portfolios with too few holdings to be properly diversified with respect to idiosyncratic risks can be hedged with respect to idiosyncratic risk through the use of such event contracts. This invention's new methodology thus complements modern long-short trading strategies and other strategies practiced by hedge funds that focus on hedging risk in a more limited portfolio.

### SUMMARY OF THE INVENTION

The methodology encompassed by this invention concerns a novel method for hedging idiosyncratic or nonsystematic investment risk by using event contracts targeted at idiosyncratic risks associated with an underlying investment. An investment's idiosyncratic or nonsystematic risk factors can be conceived of as a menu of events specific to the company whose probability of actually occurring in the future falls somewhere between zero and one hundred percent. If the investment trades in a somewhat efficient market, the price of the investment may already reflect or “discount” the probability of risk factors idiosyncratic to the investment. An investor who believes that the probability of an event giving rise to an idiosyncratic risk occurring implied by the market price for the event contract is incorrect can hedge against the adverse event occurring by entering into an event contract in which the strike—the trigger for payouts under the contract—is the event occurring. An investor whose underlying investment would suffer a decline in value would take the “long” position on the event contract and thus receive a payout if the event occurs. As with establishing any hedge, the investor would have to purchase enough contracts to cover the value of the investment being hedged and to pick an event contract that covers the time frame during which the investor believes the event will take place.

An investor using event contracts to hedge can attempt to contract directly with counter parties. With event contracts that trade on an organized exchange, the investor can buy or sell contracts directly through the exchange.

Hedging of idiosyncratic risk factors can be implemented using event contracts structured in a wide variety of ways, including but not limited to digital event option contracts, vanilla event option contracts, event forward or future contracts, and event swaps. The payout of the event contract can be a fixed payment or series of fixed payments or it can be a payment or series of payments that increase in size depending on the extent to which the event exceeds or falls short of the benchmark used as the strike. The event used as the strike can be binary—either it does or does not occur—or it can be statistical so that the extent of under or over performance with respect to the benchmark strike can be measured and quantified.

This methodology can be used in connection with any investment whose variability of returns depends at least in part on idiosyncratic risks.

The underlying investment being hedged can be a particular company's security, e.g. a stock, bond, convertible bond, or financial derivative such as a standard equity option. The types of idiosyncratic risk that event contracts could be used to hedge with respect to such underlying investments include meeting key product or subscriber growth rates, meeting deadlines for new product launches, obtaining regulatory approval, resolving legal issues or other company security specific issues. An investor in a mutual fund faces idiosyncratic risks such as the possibility of the fund manager resigning or the possibility of legal entanglements and can hedge such risks through the use of event contracts, using the methodology set forth in this invention.

This invention's methodology also permits the hedging of idiosyncratic risks that affect a group of investments that share an attribute that make them vulnerable to one or more idiosyncratic risk factors. For example, income seeking investors who invest primarily in dividend paying stocks experience greater than average exposure to the risk that the government may raise the income tax rate on dividends. Such investors can hedge that risk by taking a long position in event contracts for which passage of legislation raising the income tax rate on dividends represents the strike. Investors may also hold investments that may decline in value depending on other idiosyncratic risk factors such as an increase in the long term capital gains tax rate, an increase in the short term capital gains tax rate and other idiosyncratic risks including risks arising from changes in governmental tax and regulatory policies.

An investor that has taken a short position with respect to an investment or a category of investments subject to idiosyncratic risk may also hedge that short position by employing this invention's hedging methodology. Someone shorting a group of high dividend paying stocks, to use the earlier example, may want to hedge against the idiosyncratic risk that the government might cut the income tax rate on dividends, which, all other things being equal, would make high dividend paying stocks more valuable and the investor's short position less valuable. Instead of diversifying, the investor can take a long position or purchase event option contracts that strike or require a payout to the investor if the government cuts the income tax rate on dividends.

A business that seeks to hedge risks arising from investments of its own capital or of borrowed funds (e.g. bank loan) may also use event contracts to hedge idiosyncratic risk factors that affect the variability of returns from this operational investment or investment made by an entity or individual in connection with its ongoing business or personal activities. A biotechnology company reliant on governmental funds for the company's investment in stem cell research and development can hedge against a possible cutoff of governmental funding by purchasing or taking a long position in an event contract that pays the buyer of the event contract if the government fails to continue funding for the company's stem cell research. Another example of the methodology set forth in this invention being applied to operational investments is that of a company that has issued insurance policies using event contracts to hedge against the possible occurrence of events that would require a payout by the company under the policy. Still another example is an individual who has purchased an airline ticket using event contracts to hedge against the possible occurrence of events that would require a cancellation of the flight that he has already booked.

The underlying investment whose idiosyncratic risk is being hedged need not itself trade on an exchange as the stem cell, insurance and airline ticket examples illustrate. The idiosyncratic risk hedging strategy disclosed and claimed herein can be implemented with respect to liquid underlying investments or illiquid underlying investments.

### BRIEF DESCRIPTION OF THE DRAWINGS

The objects, advantages and features of the invention will become more apparent by reference to the drawings, which are appended hereto and made a part hereof.

FIG. 1 depicts the basic steps taken to hedge idiosyncratic investment risk using event contracts.

FIG. 2 illustrates a scenario in which an investor that has a long position in a company's stock employs a long position in a vanilla event option contract to hedge against the possibility that the company receives a fine that causes the company's stock to fall in price.

FIG. 3 uses probability trees to illustrate how an investor with a long position in a company's stock may use vanilla event option contracts to increase the expected value of the event's impact on the investor's position if the investor correctly perceives that the market has failed accurately to price in the possibility that the company will be fined. FIG. 3 also illustrates that a hedging strategy would give the investor less variability in possible outcomes and reduce the maximum possible loss.

FIG. 4 illustrates a scenario in which an investor that has a short position in a company's stock employs a long position in digital event contracts to hedge against the possibility that the Chief Executive Officer (“CEO”) of the company resigns, which would mean that the stock price does not fall by as much as hoped for by the investor or that the stock price increases.

FIG. 5 uses probability trees to illustrate how an investor with a short position in a company's stock may use a long position in digital event contracts to increase the expected value of the event's impact on the investor's position if the investor correctly perceives that the market has failed accurately to price in the possibility that the company's CEO will resign. FIG. 5 illustrates as well that a hedging strategy would give the investor less variability in possible outcomes and reduce the maximum possible loss.

FIG. 6 illustrates a scenario in which a company that has invested in stem cell research employs a short position in digital event contracts to hedge against a possibly adverse governmental ruling on stem cell research funding.

FIG. 7 uses probability trees to illustrate how a company that has made an internal investment in stem cell research may use a short position in digital event options to increase the expected value of the event's impact on the company's position if the company correctly perceives that the market has failed to accurately price in the possibility of an adverse governmental ruling on funding the company's stem cell research. FIG. 7 illustrates as well that a hedging strategy would give the investor less variability in possible outcomes and reduce the maximum possible loss.

FIG. 8 illustrates a scenario in which an investor who has taken a long position in a company's stock uses an event swap contract to hedge against the possibility that a labor strike will cause a decline in the stock's value.

FIG. 9 uses probability trees to illustrate how an investor with a long position in a company's stock uses an event swap contract to increase the expected value of the event's impact on the investor's position if the investor correctly perceives that the market has failed accurately to price in the possibility of a labor strike. FIG. 9 illustrates as well that a hedging strategy would give the investor less variability in possible outcomes and reduce the maximum possible loss.

### DESCRIPTION OF THE PREFERRED EMBODIMENT

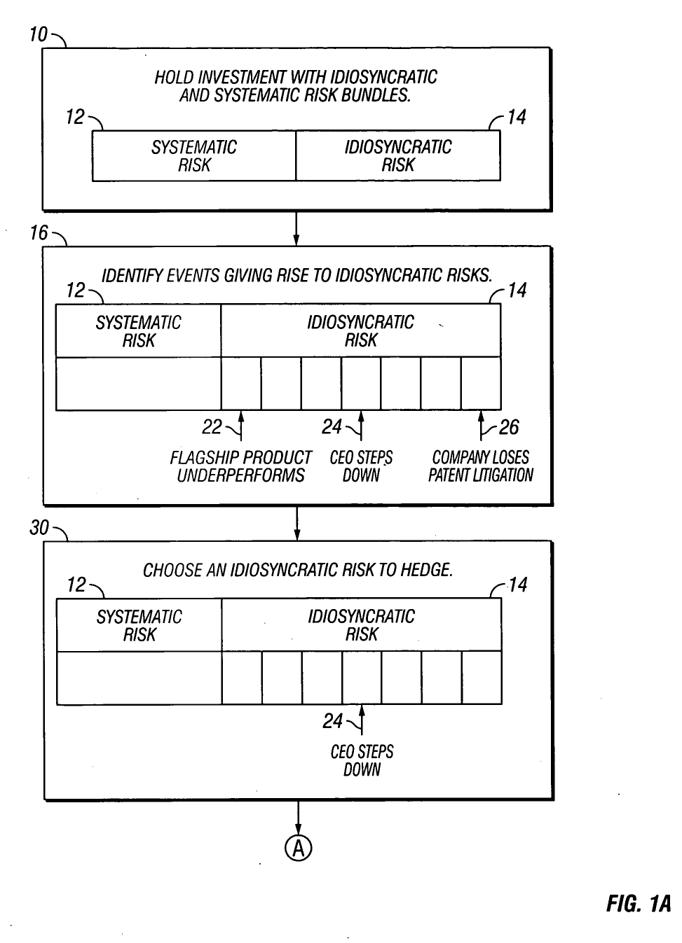

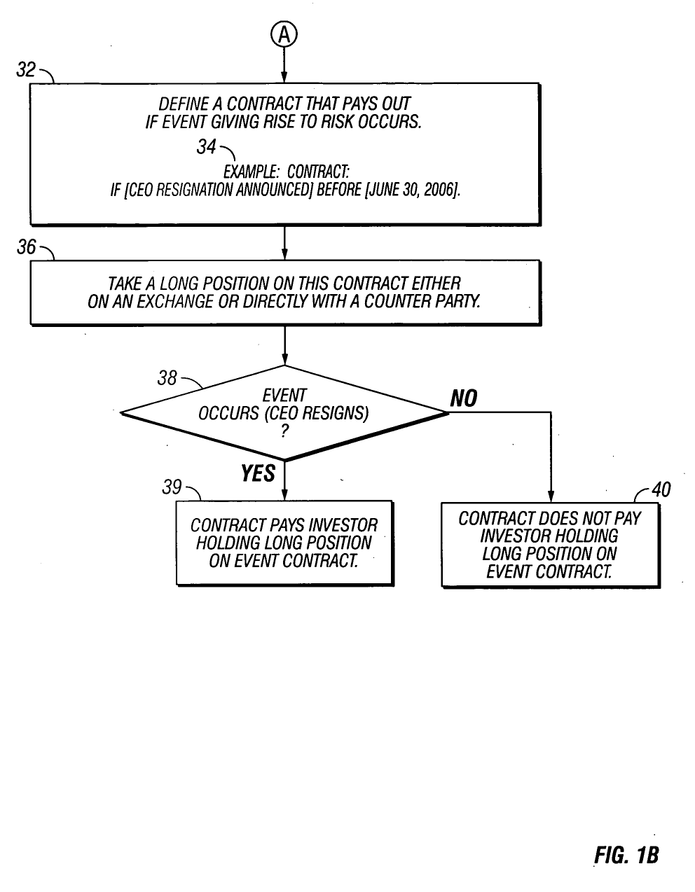

This invention's methodology for hedging idiosyncratic investment risk using event contracts is illustrated in FIGS. 1A and 1B. Because the methodology involves hedging, as illustrated in FIG. 1A, the investor first must hold 10 an investment comprised of both systematic risk 12 and idiosyncratic risk 14. The investor's position in the investment can be either long, which is the assumption being made in FIGS. 1A and 1B, or short. The investment can be liquid or illiquid and can be an operational investment (e.g. an issued insurance policy) made by a company.

As further illustrated in FIG. 1A, the investor must identify the events whose possible future occurrence comprise the idiosyncratic risks for that investment 16, such as underperformance by the flagship product 22, the resignation of the Chief Executive Officer (“CEO”) 24 and a loss in patent litigation 26. These events, should they come to fruition, would cause a decline in the stock price and would be adverse to the investor's long position in the stock.

The investor can choose, as shown in FIG. 1A, any one or any combination of these idiosyncratic event risks to hedge 30. In the example given in FIGS. 1A and 1B, the investor opts to hedge the possibility that the CEO resigns 24, 30.

The investor then defines an event contract that requires a payout to someone who takes a long position on the event, here the CEO's resignation, occurring 32, as shown in FIG. 1B. In this example, the event contract requires a payout to an investor long the event occurring if 34 the CEO announces his resignation prior to Jun. 30, 2006. The investor then takes a long position on the contract 36. If the event or strike occurs, here the CEO resigns before Jun. 30, 2006, 38, the contract requires a payout to the investor 39 thus acting as a hedge to the decline in stock price resulting from the CEO's resignation. If the event or strike does not occur, i.e. the CEO does not resign before Jun. 30, 2006, the contract does not pay the investor holding a long position in the event contract 40.

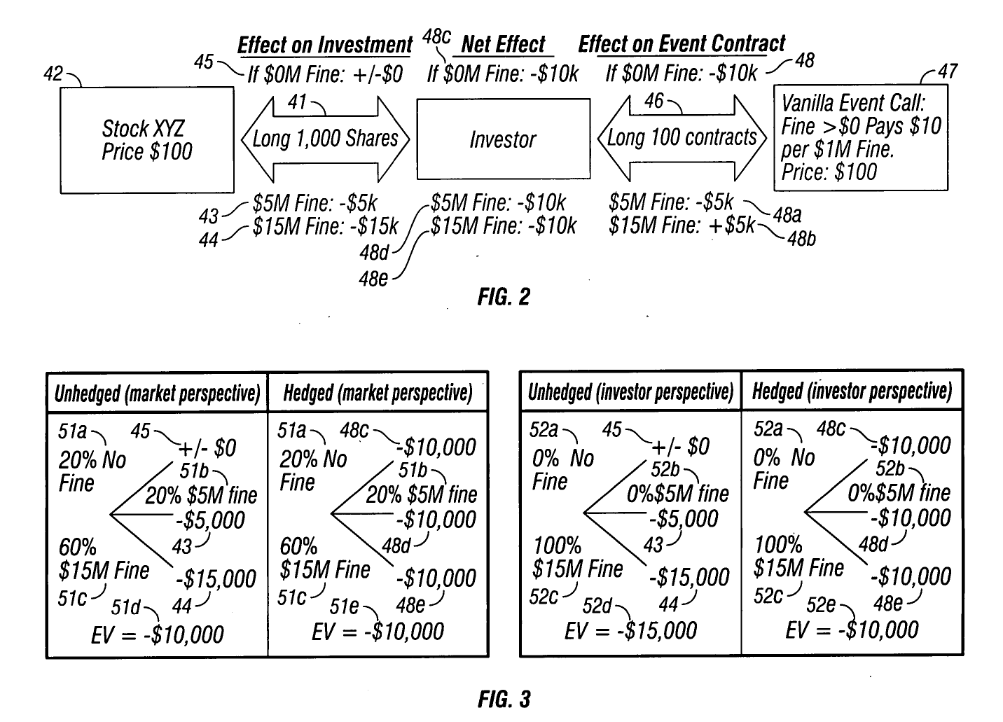

FIG. 2 illustrates a scenario in which an investor has purchased and maintained a 1,000 share long position in the stock of XYZ company 41, which at the time the hedge is implemented trades at $100 per share 42 for a total portfolio value at that time of $100,000. The investor has identified an event whose possible occurrence gives rise to an idiosyncratic risk that the investor chooses to hedge. A government regulatory agency is investigating XYZ company and may decide to impose a fine on the company that would cause a decline in XYZ's stock price. The investor believes that imposition of a $5 million dollar fine would cause a $5 per share drop in stock price or a total loss of $5,000 to the investor 43 while imposition of a $15 million dollar would cause a $15 per share drop in the stock price or 44 a total loss of $15,000. If the agency decides not to impose a fine, XYZ's stock price remains unchanged 45. In sum, as indicated in FIG. 2 and reflected in FIG. 3, the investor's position in XYZ stock suffers a $15,000 decline with a $15 million fine 44, a $5,000 decline with a $5 million fine 43, and no impact if there is no fine 45.

In the preferred embodiment set forth in FIGS. 2 and 3, the investor purchases a long position in an event contract that pays the investor if the event underlying the idiosyncratic risk—here imposition of a fine—actually occurs. As illustrated in FIG. 2, the investor thus purchases 100 vanilla event option contracts 46 at a price of $100 per contract—for a total cost of $10,000—that each pay the buyer of the contract $10 for each $1 million worth of fine imposed by the government agency 47. If no fine is imposed, the buyer of the contract still must pay $10,000 for the 100 contracts 48. With a $5 million fine, the buyer nets −$5,000 from the vanilla event call option contracts, 48a, because he pays $10,000 for the contracts and receives a payment of $5,000 from the seller of the contracts. The buyer nets $5,000 from the vanilla event option contracts if XYZ company receives a $15 million fine 48b—paying $10,000 for the contracts and receiving a payment of $15,000 from the seller of the contracts. In sum, the investor's position in vanilla event call option contracts nets −$10,000 if there is no fine 48, −$5,000 if there is a $5 million fine 48a and +$5,000 with a $15 million 48b.

As illustrated in FIGS. 2 and 3, the net effect on the investor's position—factoring in both the stock holding and the vanilla event call option contracts is −$10,000 in all three fine scenarios—no fine 48c, $5 million fine 48d and $15 million fine 48e.

As illustrated in FIG. 3, the investor may choose to purchase the vanilla option contracts because of the investor's expectation that, as reflected in market prices for the vanilla event call option contracts, the market has underestimated the probability of a fine being imposed. In FIG. 3, the market assumes a 20% probability of no fine 51a, a 20% probability of a $5 million dollar fine 51b and a 60% probability of a $15 million fine 51c. The investor anticipates no chance of having no fine imposed 52a, no chance of a $5 million fine 52b, and a 100% probability of a $15 million fine 52c. The expected value of the fine's impact on the investor's position—the sum of the product of each fine scenario's probability with the dollar value impact resulting from that scenario's occurrence—is reduced from −$15,000 (unhedged), 52d, to −$10,000 (hedged using vanilla event call option), 52e, if the investor's expectations regarding probabilities of occurrence are correct.

The investor may choose to employ the vanilla event call option hedging strategy even if the market's expectations, as reflected in the price of the vanilla event call option contracts, regarding probabilities of occurrence are correct. In such a scenario, the investor receives the same expected value (−$10,000) whether unhedged 51d (20%*0+20%* −$5,000+60%*−$15,000) or hedged 51e (20%*−$10,000+20%*−$10,000+60%* −$10,000). However, the unhedged market scenario—even assuming the market has correctly priced the risk of the event occurring—results in a larger maximum loss 44 and a greater variability of actual result, ranging from an impact of $0 (no fine) 45 to −$5,000 ($5 million fine) 43 to −$15,000 ($15 million fine) 44. In contrast, the investor faces a net impact of −$10,000, if hedged, regardless of whether a fine is imposed, 48c, 48d, 48e.

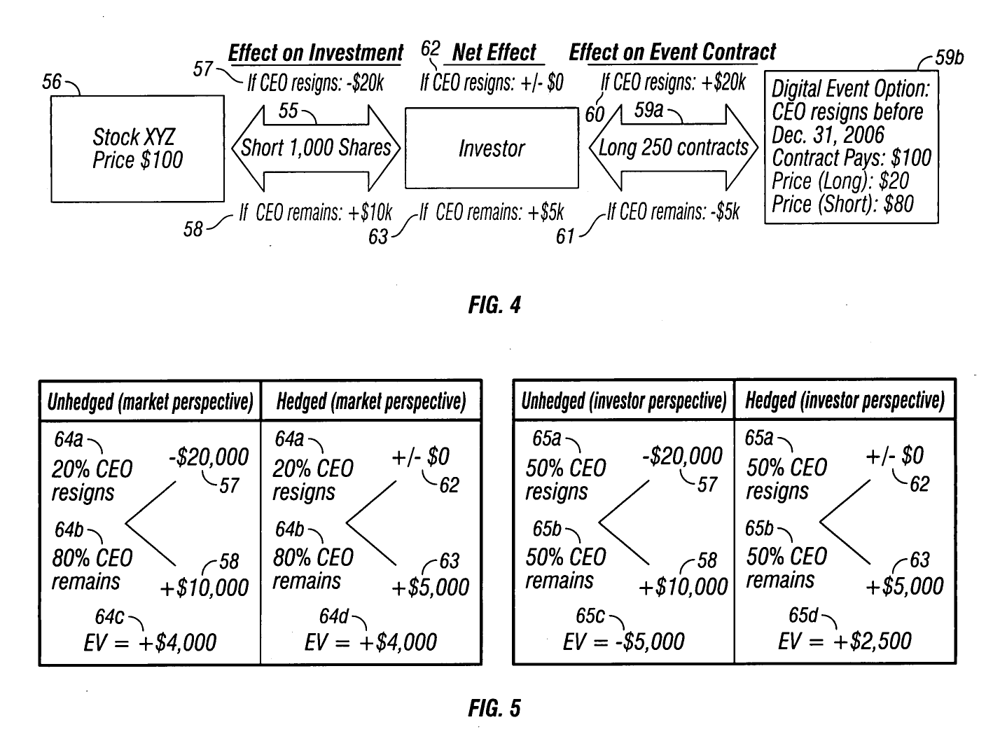

The methodology set forth in this invention can also be implemented when the investor has taken a short position in the underlying investment and regardless of the form of the event contract, as illustrated in another preferred embodiment set forth in FIGS. 4 and 5, which demonstrate the methodology using an underlying short position in an investment and hedging idiosyncratic event risk with digital event options.

In FIG. 4, the investor has sold short 1,000 shares of XYZ company stock 55 so that the investor's holding in XYZ stock is worth $100,000 at the stock price of $100 per share 56 at the time the hedge is implemented. The investor has identified the possible occurrence of an event that gives rise to idiosyncratic risk—the CEO of XYZ company resigns—that would cause the stock price to increase by $20 per share at a cost of $20,000 to the investor's 1000 share short position if it occurs 57. If the CEO remains, the value of the investor's short position in XYZ stock will increase 58 by $10,000 or, in other words, the price of the stock will decline by $10 per share. In sum, if unhedged, the investor's short investment in XYZ stock nets −$20,000 if the CEO resigns 57 and +$10,000 if the CEO remains 58, as illustrated in both FIGS. 4 and 5.

The investor buys or takes a long position in 250 digital event option contracts 59a that pay out to the investor if the event (CEO resigns before Dec. 31, 2006) giving rise to the idiosyncratic risk sought to be hedged occurs 59b. The digital event option contracts cost $20 per contract to purchase a long position 59b, $80 per contract to purchase a short position 59b and pay $100 per contract to the buyer if the CEO resigns 59b before Dec. 31, 2006 and $100 per contract to the seller if the CEO does not resign 59b before Dec. 31, 2006. The investor, who has taken a long position, nets $80 per contract if the CEO resigns by the date specified (pays $20 to seller for each contract but receives $100 from seller per contract upon occurrence of the event), or $20,000 in all for 250 contracts 60. The investor nets −$5,000 from his position in the digital event option contracts 61 if the CEO remains past Dec. 31, 2006—paying $100 per contract to the seller but receiving $80 per contract on 250 contracts. In sum, the investor's long position in the 250 digital event option contracts, standing alone, nets the investor +$20,000 if the CEO resigns 60 and −$5,000 if the CEO remains 61.

As illustrated in FIGS. 4 and 5, the effect on the investor's hedged position—factoring in the short stock position and the impact of the digital event option contracts—is no change 62 if the CEO resigns and +$5,000 if the CEO remains 63.

In this example, as illustrated in FIG. 5, the investor perceives the risk of the adverse event (here, CEO resignation) to be higher than that implicit in the market price of the digital event options purchased by the investor. The market assumes a 20% probability of CEO resignation by the date specified 64a and an 80% probability of the CEO remaining 64b past that date. The investor anticipates a 50% probability of the CEO resigning 65a and a 50% probability of the CEO remaining 65b. Based on the investor's expectations, the investor can reduce the expected value of the impact of the CEO not resigning from −$5,000 (unhedged) 65c to +$2,500 (hedged) 65d.

The investor may choose to employ the digital event option hedging strategy even if the market's expectations regarding probabilities of occurrence are correct and are priced into the digital event option contracts. In such a scenario, the investor receives the same expected value ($4,000) whether unhedged 64c or hedged 64d. The unhedged impact—even assuming the market (and not the investor) has correctly priced the risk of the event occurring—results in a larger maximum loss 57 and greater variability of actual result, ranging from $10,000 (CEO remains) 58 to −$20,000 (CEO resigns) 57. With respect to actual (as opposed to expected) value of possible outcomes, the investor, if hedged, experiences no net loss if the CEO resigns 62 and a $5,000 gain if the CEO remains 63, as illustrated in both FIGS. 4 and 5.

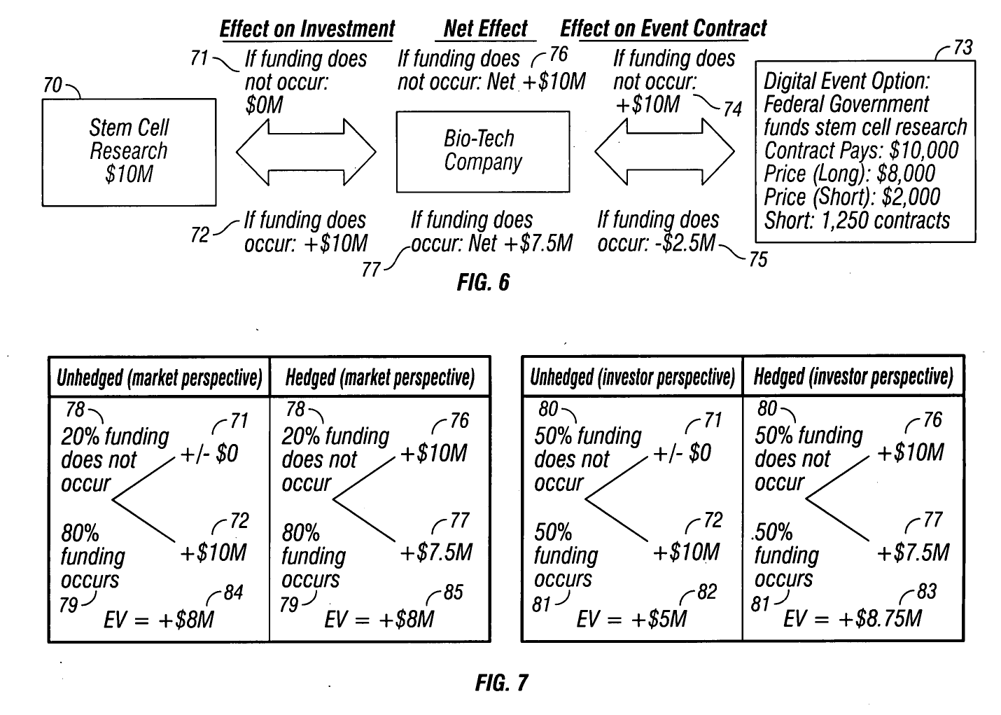

Another preferred embodiment implements the hedging strategy set forth in this invention with respect to a company's operational investments, as illustrated in FIGS. 6 and 7. This preferred embodiment also illustrates that the hedging strategy set forth in this invention can be implemented by shorting event contracts. FIG. 6 illustrates a scenario in which a company's planned receipt of $10 million in government funding to carry out research and development in stem cell research 70 would be jeopardized if federal government stem cell research funding to the company is discontinued. If the government discontinues the funding, the company receives nothing instead of the $10 million 71. If the government decides to continue the funding, the company nets the $10 million 72. In sum, if unhedged, the government will either receive $10 million 72 or nothing 71.

The company has identified an event (government cutoff of stem cell funding) that creates an idiosyncratic risk that affects its planned investment in stem cell research. The company must then take a position in event contracts that pay out to the company if the government cuts off stem cell funding. As illustrated in FIG. 6, the company thus purchases a short position in 1,250 digital event option contracts 73. Each contract pays the party taking a short position $ 10,000 if the government does not fund stem cell research 73 and the party taking a long position $10,000 if the government funds stem cell research 73. Purchasing a long position costs $8,000 per contract 73 while purchasing a short position costs $2,000 per contract 73. The company's short position in the digital event contracts nets the company $8,000 per contract (pay $2,000 per contract and receive $10,000 per contract) 73 if the government does not fund stem cell research, which translates to a net $10 million ($8,000*1,250 contracts) for the company's short position in 1,250 contracts 74. If the government funds stem cell research, the company nets −$2,000 per contract (receive $8,000 from party taking long position per contract and pay said party $10,000 per contract) for a total net of −$2.5 million for 1,250 contracts 75. In sum, with respect to the digital event option contracts standing alone, the company nets +$10 million if funding does not occur 74 and −$2.5 million if funding does occur 75.

As illustrated in FIGS. 6 and 7, the net effect on the company's hedged position—factoring in the long position on government funding and the short position in the digital event option contracts—is +$10 million absent funding 76 and +$7.5 million with funding 77.

In this example, as illustrated in FIG. 7, the company perceives the probability of the adverse event occurring (here, no government funding) to be higher than that implicit in the market price of the digital event options shorted by the company. The market assumes a 20% probability of no funding 78 and an 80% probability of government funding 79. The company anticipates a 50% probability of no funding 80 and a 50% probability of funding 81. If the company's expectations are correct, the company can reduce the expected value of the impact of a government decision not to fund from +$5 million (unhedged) 82 to +$8.75 million (hedged) 83.

If the market, and not the company, is correct regarding the possibility of the adverse event (no government funding) occurring and has priced the digital event option contracts accordingly, the company cannot affect, as illustrated in FIG. 7, the expected value of the impact of no funding on the company's position as the expected value is +$8 million whether unhedged 84 or hedged 85. The maximum possible loss 71 and the variability in the actual value of the company's position remains much greater if the company remains unhedged, with the possible value ranging from nothing (if no funding) 71 to +$10 million (if funding) 72, if unhedged, compared with a range of +$10 million (if no funding) 76 to +$7.5 million (if funding) 77 if hedged. For this reason, a company that prefers to reduce the impact of the government's funding decision on the variance of possible changes in the actual (as opposed to expected) value of the company's position can hedge against the possibility of the government deciding not to fund.

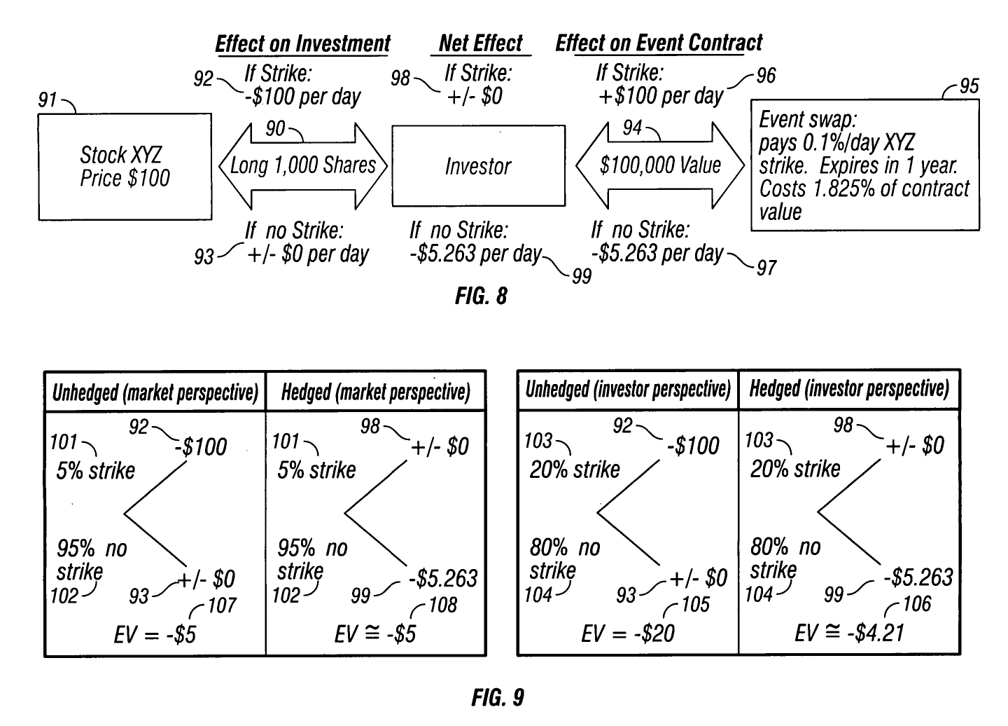

Another preferred embodiment would employ an event swap contract to hedge against a possible labor strike that would adversely affect an investor's position in XYZ stock, as illustrated in FIGS. 8 and 9. In FIG. 8, the investor has purchased or taken a long position in 1,000 shares of XYZ stock, which trades at $100 per share 91 at the time the investor enters into the swap contract for a total position in XYZ stock worth $100,000. A strike by XYZ's workforce would reduce the dollar value of the investor's position in XYZ stock by $100 per day or 0.1% a day 92. In the absence of a strike, the investor's position in XYZ stock remains unchanged in value 93. In sum, if unhedged, the investor's position in XYZ stock will remain unchanged in the absence of a strike 93 and will decline by $100 per day if there is a strike 92.

Having identified the possible occurrence of a strike as the event giving rise to idiosyncratic risk, the investor hedges that risk by taking a long position in an event swap 94 with a face value of $100,000.—The event swap contract expires in a year 95 and during that period pays 0.1% for each day XYZ's workforce strikes 95, which translates into a payment of $100 per day 96. The investor has to pay the counter party 1.825% of the face value of the contract per annum or $1,825 to enter into the contract 95, which translates into a cost of $5.263 for each day that the event swap remains in effect 97. In sum, the investor receives $100 per day from the event swap contract if there is a strike 96 and, absent a strike, pays $5.263 per day to maintain his position in the event swap 97.

The investor's net position if hedged—combining the impact of the strike on the investment in XYZ stock and on the payouts from the event swap—would be no effect if there is a strike 98 and a loss of $5.263 a day in the absence of a strike 99.

As illustrated in FIG. 9, the investor perceives the probability of the adverse event occurring (here, a strike) to be higher than that implicit in the market price of the event swap contract in which the company has taken a long position. The market assumes a 5% probability of a strike 101 and a 95% probability of no strike 102. The investor expects a 20% probability of a strike 103 and a 80% probability of no strike 104. If the investor's expectations are correct and the market's erroneous, the investor can reduce the expected value of the impact of a strike from −$20 per day (unhedged) 105 to approximately −$4.21 per day (hedged) 106.

The market's pricing of the event swap may have correctly predicted the probability of a strike occurring in which case, as illustrated in FIG. 9, hedging again fails to change the expected value of the adverse event (i.e. strike)'s impact on the investor's position, as the expected values of the investor's position when unhedged (−$5) 107 and hedged (approximately −$5) 108 are the same. An investor may prefer to hedge regardless because the maximum possible loss (−$100 per day unhedged 92 v. $0 hedged 98) and the variability of actual impact on the investor's position is less when hedged 98, 99 than when not hedged 92, 93.

Another preferred embodiment would use event forward or futures contracts to hedge an idiosyncratic risk that arises from a so-called statistical event that can be pegged to a numerical benchmark as illustrated in the following scenario.

A company plans to invest $10 million resources in a new and untested product for a developing market. They have forecasts of possible market size that project at least 5 million users by the end of year 2006. The company will break even in terms of profitability if the product has at least 5 million users. The company will earn $1.5 million in profit for each hundred thousand users by which the market size exceeds 5 million users and lose $1 million for each hundred thousand users by which the market falls short of 5 million users. The company decides to hedge the risk that the market is not big enough for the company to at least achieve break even, i.e. that the market size for the product falls below 5 million users.

The company enters into an event futures contract with a counter party with a strike set at 5 million users of the product by Dec. 31, 2006. Because the company wants to be hedged (i.e. to receive a payout) if user numbers fall short of that required for break even, the company takes a short position in the futures event contract. The futures contract requires the counter party to pay the company $1 million for each hundred thousand users by which the actual market size falls below the strike and the company to pay the counter party $1 million for each hundred thousand users by which the actual market size exceeds the strike. The company prefers the futures contract because it-wants to avoid committing resources to paying a premium today for an option and because the company believes its incremental profitability for a market size in excess of 5 million users will outweigh the cost of the event future. The company's hedged investment would result in a $500,000 profit for each hundred thousand users by which the market exceeds 5 million users and no profit or loss for each hundred thousand users by which the actual market falls short of 5 million users. This example makes no assumptions about market mispricing of the idiosyncratic risk being hedged so that the scenario does not assume that the company can increase the expected value of its position by hedging the idiosyncratic risk. Nonetheless, the company can accept this lower ceiling on its profitability because the hedge also decreases the company's maximum possible loss and variability in possible outcomes.

Yet another preferred embodiment illustrates how digital event options can be used to hedge idiosyncratic risks arising from a company's operational investments, as illustrated in the following scenario.

A company has recently invested $25 million in a new ABC server platform for its IT system. However, with server technology evolving quickly and the cut throat competition in the marketplace for servers, the company fears that support and maintenance for its chosen platform may be discontinued, rendering its installed server platform useless and requiring another expenditure of $25 million to replace, if the company's current vendor is forced out of business. Having identified the possible discontinuation of the server platform by Dec. 31, 2008, as the event giving rise to an undesirable idiosyncratic risk, the company decide to hedge this risk by buying or taking a long position in binary event options that requires a payout to the company if the strike (i.e. ABC server platform is discontinued by Dec. 31, 2008) occurs. The market has priced long positions in the contracts at $20 each with a mature value of $100 (i.e. payout of $100 per contract) and short positions in the contracts at $80 with a mature value of $100. If the event occurs, the company, which has purchased a long position, gains a net of $80 per contract (pay $20 per contract and receive $100 per contract) on its position in the digital event options. The company loses a net of $20 per contract (pay $100 to seller per contract and receive $80 from seller per contract) on its position in the digital event option contracts if the event does not occur. Having purchased 312,500 contracts, the company's net hedged position if the ABC server platform is discontinued by the specified date turns out to be no net gain or loss (receive $25 million from the 312,500 contracts but lose $25 million from having to replace server platform. The company's net hedged position if the server platform is not discontinued by the specified date would be a −$6.25 million (pay $6.25 million to the sellers of the 312,500 contracts and no replace costs for server platform). The exchange or broker may require them to set aside $6,250,000 to cover the company's potential loss on the contracts if the ABC server platform is not discontinued by Dec. 31, 2008. Because it makes no assumptions about mispricing of the idiosyncratic risk being hedged, this scenario does not claim increasing the expected value of the company's position as a benefit. Nonetheless, the company prefers to set aside the funds today to avert the risk that its $25 million investment in the ABC server platform becomes a total loss, which is the maximum possible loss, and to enjoy less variability in possible outcome with respect to discontinuation of service for the ABC server platform.

These illustrative examples of different preferred embodiments demonstrate that an investor can enhance the expected value of its position in an underlying investment when combined with a hedge using an event contract targeted at an idiosyncratic risk if the investor correctly detects and develops a strategy to benefit from the market's mispricing of that risk. Moreover, even absent market mispricing, hedging idiosyncratic risk using event contracts permits an investor to reduce the variability of actual outcomes and the maximum possible loss.

Modern behavioral finance describes investors who dislike losing money more than they like gaining money. Many investors also prefer a less varied range of outcomes. Some hedge funds have focused on developing strategies to minimize any adverse change in portfolio value so that they will grow slowly but steadily. Hedging, though having the same expected value as not hedging when the market is fairly valued, can result in a smoother record of returns, which is preferred over a wildly volatile record that results in the same final value.

The scope of the invention is not to be limited by the examples set forth but only by the appended claims and their legal equivalents.

What is claimed is:

1. A method for a holder of a position in an investment to hedge idiosyncratic risk in said investment, said method comprising the steps of:
said holder taking said position in said investment subject to said idiosyncratic risk;
identifying event whose possible occurrence in the future gives rise to said idiosyncratic risk to which said investment is subject;
said holder taking a position in event contract that requires a payout to said holder of said investment if said event occurs.

2. The method of claim 1, in which said position taken in said event contract is a short position.

3. The method of claim 1, in which said event contract is a digital event option contract.

4. The method of claim 1, in which said event contract is a vanilla event option contract.

5. The method of claim 1, in which said event contract is an event forward contract.

6. The method of claim 1, in which said event contract is an event futures contract.

7. The method of claim 1, in which said event contract is an event swaps contract.

8. The method of claim 1, in which said event contract combines two or more event contracts.

9. The method of claim 1, further comprising the step of determining whether the market has mispriced said idiosyncratic risk arising from said event as a factor in deciding whether to take said position in said event contract.

10. The method of claim 1, further comprising the step of determining whether taking said position in said event contract would result in less variability in possible outcomes as a factor in deciding whether to take said position in said event contract.

11. The method of claim 1, further comprising the step of determining whether taking said position in said event contract would reduce the maximum possible loss as a factor in deciding whether to take said position in said event contract.

12. The method of claim 1, in which said investment is a short position.

13. The method of claim 1, in which said investment is illiquid.

14. The method of claim 1, in which said investment is an operational investment.

15. The method of claim 14, in which said operational investment is an issued insurance policy.
